(19) United States
(12) Patent Application Publication
(10) Pub. No.: US 2012/0215403 A1
(43) Pub. Date: Aug. 23, 2012

(54) METHOD OF MONITORING A VEHICLE DRIVER

(75) Inventors: Steven C. Tengler, Grosse Pointe Park, MI (US); Mark S. Frye, Grosse Pointe Woods, MI (US)

(73) Assignee: GENERAL MOTORS LLC, Detroit, MI (US)

(21) Appl. No.: 13/031,234

(22) Filed: Feb. 20, 2011

(51) Int. Cl. G06F 7/00

(52) U.S. Cl. 701/36

(57) ABSTRACT

A method of monitoring a vehicle driver involves monitoring any of an eye or facial position of the vehicle driver via a tracking device operatively disposed in a vehicle that is then-currently in operation. Based on the monitoring, via a processor operatively associated with the tracking device, the method further involves determining that the eye or facial position of the vehicle driver is such that the vehicle driver's eyes are, or the vehicle driver's face is focused on an object disposed inside an interior of the vehicle. In response to the determining, a functionality of the object is automatically altered.

### TECHNICAL FIELD

The present disclosure relates generally to methods of monitoring a vehicle driver.

### BACKGROUND

Some in-vehicle objects are often useful to a vehicle driver while he/she is operating a vehicle. For example, an in-vehicle display unit may advantageously be used to present navigation instructions to the vehicle driver while he/she is driving toward a particular destination point.

### SUMMARY

A method of monitoring a vehicle driver involves monitoring any of an eye or facial position of the vehicle driver via a tracking device operatively disposed in a vehicle that is then-currently in operation. Based on the monitoring, via a processor operatively associated with the tracking device, the method further involves determining that the eye or facial position of the vehicle driver is such that the vehicle driver's eyes are or the vehicle driver's face is focused on an object disposed inside an interior of the vehicle. In response to the determining, a functionality of the object is automatically altered.

### BRIEF DESCRIPTION OF THE DRAWINGS

Features and advantages of examples of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1 is a schematic diagram depicting an example of a system for monitoring a vehicle driver;

FIG. 2A semi-schematically depicts an example of a vehicle interior and a vehicle driver with his eyes focused on an in-vehicle display unit;

FIG. 2B semi-schematically depicts another example of the vehicle interior shown in FIG. 2A and the vehicle driver with his eyes focused on the road; and

FIG. 3 semi-schematically depicts a fence constructed around an object whose functionality may be altered, the fence defining a proximate direction in which the vehicle driver's eyes and/or face may be directed.

### DETAILED DESCRIPTION

Examples of the method disclosed herein may advantageously be used to monitor a vehicle driver while he/she is operating a vehicle. This may be accomplished by utilizing a tracking device, which is operatively disposed inside the interior of the driver's vehicle. The tracking device determines an eye and/or facial position of the vehicle driver while he/she is driving. The eye and/or facial position is used to determine, for example, when the vehicle driver's eyes are, or face is focused on a particular object disposed inside the vehicle interior. If the driver's eyes are and/or face is found to be focusing on the in-vehicle object, the functionality of that object is automatically altered until the driver re-focuses his/her eyes/face somewhere else, such as back on the road.

As used herein, the term “vehicle driver” or “driver” refers to any person that is then-currently operating a mobile vehicle. In one example, the “vehicle driver” may be a vehicle owner or another person who is authorized to drive the owner's vehicle. Further, in instances where the vehicle driver is a telematics service subscriber, the term “vehicle driver” may be used interchangeably with the terms user and/or subscriber/service subscriber.

It is to be understood that when the vehicle driver is “operating a vehicle”, the vehicle driver is then-currently controlling one or more operational functions of the vehicle. One example of the vehicle driver operating the vehicle is when he/she initiates the vehicle ignition, sets the vehicle in motion, etc. For example, the vehicle driver is considered to be “operating a vehicle” when the driver is physically steering the vehicle and/or controlling the gas and brake pedals while the transmission system is in a mode other than a park mode (e.g., a drive mode, a reverse mode, a neutral mode, etc.).

Additionally, when the vehicle is “then-currently in operation”, the vehicle is powered on and one or more operational functions of the vehicle are then-currently being controlled by a vehicle driver.

Furthermore, the term “communication” is to be construed to include all forms of communication, including direct and indirect communication. Indirect communication may include communication between two components with additional component(s) located therebetween.

Still further, the terms “connect/connected/connection” and/or the like are broadly defined herein to encompass a variety of divergent connected arrangements and assembly techniques. These arrangements and techniques include, but are not limited to (1) the direct communication between one component and another component with no intervening components therebetween; and (2) the communication of one component and another component with one or more components therebetween, provided that the one component being “connected to” the other component is somehow in operative communication with the other component (notwithstanding the presence of one or more additional components therebetween).

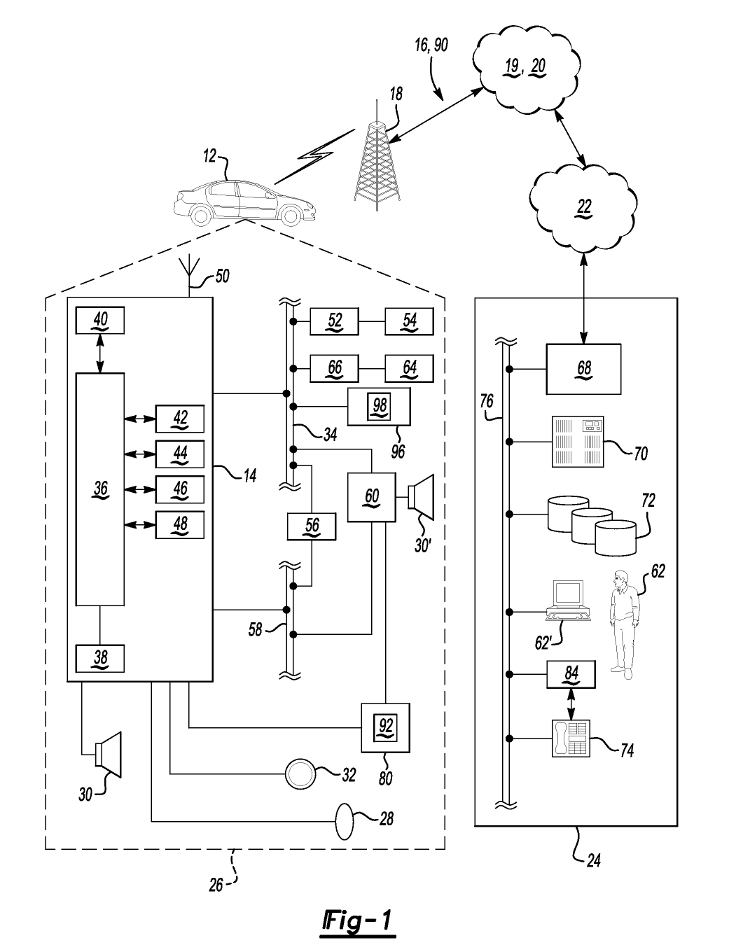

One example of a system 10 for monitoring a vehicle driver is schematically depicted in FIG. 1. This example of the system 10 generally includes a mobile vehicle 12, a telematics unit 14 operatively disposed in the mobile vehicle 12, a carrier/communication system 16 (including, but not limited to, one or more cell towers 18, one or more base stations 19 and/or mobile switching centers (MSCs) 20, and one or more service providers (e.g., 90) including mobile network operator(s)), one or more land networks 22, and one or more telematics service/call centers 24. In an example, the carrier/communication system 16 is a two-way radio frequency communication system, and may be configured with a web service supporting system-to-system communications (e.g., communications between the call center 24 and the service provider 90).

The overall architecture, setup and operation, as well as many of the individual components of the system 10 shown in FIG. 1 are generally known in the art. Thus, the following paragraphs provide a brief overview of one example of the system 10. It is to be understood, however, that additional components and/or other systems not shown here could employ the method(s) disclosed herein.

Vehicle 12 may be a mobile land vehicle, such as a motorcycle, car, truck, recreational vehicle (RV), or the like. Thus, when operating the vehicle 12, the vehicle driver's eyes or face may be referred to as being focused on or away from the road, street, highway, trail, etc. It is to be understood, however, that the mobile vehicle 12 may also or otherwise be a vehicle other than solely a land vehicle, such as a plane, a boat, or the like. In this case, the vehicle driver's eyes or face may be referred to as being focused on or away from the air space (e.g., for a plane) or on or away from the waterway (e.g., for a boat) when operating the vehicle 12.

For purposes of illustration, the system 10 will be described below using a car as the mobile vehicle 12, and this vehicle 12 includes a number of vehicle systems that enable for the overall operation of the vehicle 12. An example of such as system includes a vehicle ignition system, which may be used to power on the vehicle 12, for example, by turning an ignition key, pressing an ignition button inside the vehicle 12 or on a vehicle key fob, or the like. Another example of a vehicle system includes a transmission system that is responsible for the mobility of the vehicle 12. The transmission system generally utilizes a transmission shifting lever to switch between various operational modes of the vehicle 12, such as between a drive mode, a park mode, a reverse mode, etc. The transmission system may be manual or automatic.

The vehicle 12 is further equipped with suitable hardware and software that enables it to communicate (e.g., transmit and/or receive voice and data communications) over the carrier/communication system 16.

Some of the vehicle hardware 26 is shown generally in FIG. 1, including the telematics unit 14 and other components that are operatively connected to the telematics unit 14. Examples of other hardware 26 components include a microphone 28, a speaker 30 and buttons, knobs, switches, keyboards, and/or controls 32. Generally, these hardware 26 components enable a user to communicate with the telematics unit 14 and any other system 10 components in communication with the telematics unit 14. It is to be understood that the vehicle 12 may also include additional components suitable for use in, or in connection with, the telematics unit 14.

Operatively coupled to the telematics unit 14 is a network connection or vehicle bus 34. Examples of suitable network connections include a controller area network (CAN), a media oriented system transfer (MOST), a local interconnection network (LIN), an Ethernet, and other appropriate connections, such as those that conform with known ISO, SAE, and IEEE standards and specifications, to name a few. The vehicle bus 34 enables the vehicle 12 to send and receive signals from the telematics unit 14 to various units of equipment and systems both outside the vehicle 12 and within the vehicle 12 to perform various functions, such as unlocking a door, executing personal comfort settings, and/or the like.

The telematics unit 14 is an onboard vehicle dedicated communications device. In an example, the telematics unit 14 is linked to the call center 24 via the carrier system 16, and is capable of calling and transmitting data to the call center 24.

The telematics unit 14 provides a variety of services, both individually and through its communication with the call center 24. The telematics unit 14 generally includes an electronic processing device 36 operatively coupled to one or more types of electronic memory 38, a cellular chipset/component 40, a wireless modem 42, a navigation unit containing a location detection (e.g., global positioning system (GPS)) chipset/component 44, a real-time clock (RTC) 46, a short-range wireless communication network 48 (e.g., a BLUETOOTH® unit), and/or a dual antenna 50. In one example, the wireless modem 42 includes a computer program and/or set of software routines executing within processing device 36.

It is to be understood that the telematics unit 14 may be implemented without one or more of the above listed components (e.g., the short range wireless communication network 48). It is to be further understood that telematics unit 14 may also include additional components and functionality as desired for a particular end use.

The electronic processing device 36 of the telematics unit 14 may be a micro controller, a controller, a microprocessor, a host processor, and/or a vehicle communications processor. In another example, electronic processing device 36 may be an application specific integrated circuit (ASIC). Alternatively, electronic processing device 36 may be a processor working in conjunction with a central processing unit (CPU) performing the function of a general-purpose processor. The electronic processing device 36 (also referred to herein as a processor) may, for example, include software programs having computer readable code to initiate and/or perform various functions of the telematics unit 14, as well as computer readable code for performing various steps of the examples of the method disclosed herein. For instance, the processor 36 may include a vehicle driver workload management application (which is a particular type of software program) that, when executed by the processor 36, detects when the vehicle driver is engaged in a driving maneuver, such as making a left-hand turn at an intersection. The workload management application utilizes data received from one or more vehicle systems and/or sensors (e.g., vehicle speed, a then-current location of the vehicle 12, an ON state of a vehicle turn signal, information sent from the vehicle braking system, etc.) and/or data external to the vehicle 12 (e.g., then-current traffic information obtained from the call center 24, from another facility (e.g., from the Cloud, which will be described below), from another vehicle (e.g., via vehicle-to-vehicle (V2V) communication), from on-board cameras, or the like) to determine what maneuver(s), if any, the vehicle 12 is then-currently performing As will be described in detail below, if the vehicle driver is engaged in a driving maneuver, in one example, the telematics unit 14 sends a signal to another processor 92, which is associated with an in-vehicle object (such as a display 80), so that the functionality of the object may be altered at least until the driving maneuver has been completed.

The processor 36 of the telematics unit 14 may also include software programs including computer readable code for sending a signal to the in-vehicle object to trigger a software program, encoded on a computer readable medium and executable by the processor 92 associated with the object, to automatically alter the functionality of the object. This signal is sent, for example, in response to receiving an indication that i) the vehicle driver's eyes have or face has been focused on the object for a predetermined amount of time, and/or ii) the vehicle 12 has exceeded a predetermined vehicle speed.

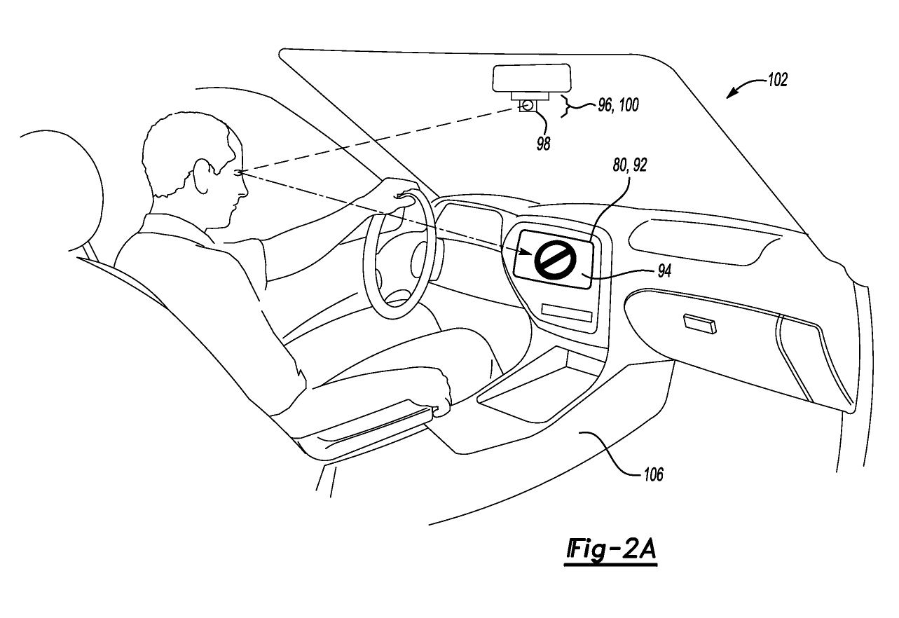

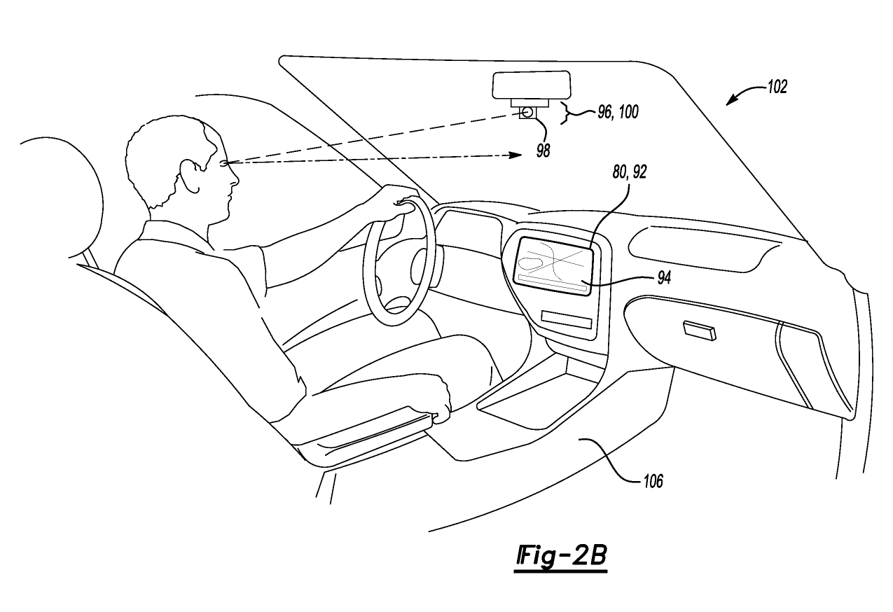

It is to be understood that the in-vehicle object whose functionality may be altered may be chosen from any object that is disposed inside the vehicle interior (identified by reference numeral 102 in FIGS. 2A and 2B). One example of such an object includes an in-vehicle display unit 80. It is to be understood that examples of the system and method will be described using the display 80 as the object having the functionality that may be altered. However, it is further to be understood that one skilled in the art would know how to adapt the teachings of the instant disclosure for other objects operatively disposed inside the vehicle interior 102.

Still referring to FIG. 1, the location detection chipset/component 44 may include a Global Position System (GPS) receiver, a radio triangulation system, a dead reckoning position system, and/or combinations thereof. In particular, a GPS receiver provides accurate time and latitude and longitude coordinates of the vehicle 12 responsive to a GPS broadcast signal received from a GPS satellite constellation (not shown).

The cellular chipset/component 40 may be an analog, digital, dual-mode, dual-band, multi-mode and/or multi-band cellular phone. The cellular chipset-component 40 uses one or more prescribed frequencies in the 800 MHz analog band or in the 800 MHz, 900 MHz, 1900 MHz and higher digital cellular bands. Any suitable protocol may be used, including digital transmission technologies, such as TDMA (time division multiple access), CDMA (code division multiple access) and GSM (global system for mobile telecommunications). In some instances, the protocol may be short-range wireless communication technologies, such as BLUETOOTH®, dedicated short-range communications (DSRC), or Wi-Fi. In other instances, the protocol is Evolution Data Optimized (EVDO) Rev B (3G) or Long Term Evolution (LTE) (4G).

Also associated with electronic processing device 36 is the previously mentioned real time clock (RTC) 46, which provides accurate date and time information to the telematics unit 14 hardware and software components that may require and/or request date and time information. In an example, the RTC 46 may provide date and time information periodically, such as, for example, every ten milliseconds.

The electronic memory 38 of the telematics unit 14 may be configured to store data associated with the various systems of the vehicle 12, vehicle operations, vehicle user preferences and/or personal information, and the like.

The telematics unit 14 provides numerous services alone or in conjunction with the call center 24, some of which may not be listed herein, and is configured to fulfill one or more user or subscriber requests. Several examples of these services include, but are not limited to: turn-by-turn directions and other navigation-related services provided in conjunction with the GPS based chipset/component 44; airbag deployment notification and other emergency or roadside assistance-related services provided in connection with various crash and or collision sensor interface modules 52 and sensors 54 located throughout the vehicle 12; and infotainment-related services where music, Web pages, movies, television programs, videogames and/or other content is downloaded by an infotainment center 56 operatively connected to the telematics unit 14 via vehicle bus 34 and audio bus 58. In one example, downloaded content is stored (e.g., in memory 38) for current or later playback.

Again, the above-listed services are by no means an exhaustive list of all the capabilities of telematics unit 14, but are simply an illustration of some of the services that the telematics unit 14 is capable of offering. It is to be understood that when these services are obtained from the call center 24, the telematics unit 14 is considered to be operating in a telematics service mode.

Vehicle communications generally utilize radio transmissions to establish a voice channel with carrier system 16 such that both voice and data transmissions may be sent and received over the voice channel. Vehicle communications are enabled via the cellular chipset/component 40 for voice communications and the wireless modem 42 for data transmission. In order to enable successful data transmission over the voice channel, wireless modem 42 applies some type of encoding or modulation to convert the digital data so that it can communicate through a vocoder or speech codec incorporated in the cellular chipset/component 40. It is to be understood that any suitable encoding or modulation technique that provides an acceptable data rate and bit error may be used with the examples disclosed herein. In one example, an Evolution Data Optimized (EVDO) Rev B (3G) system (which offers a data rate of about 14.7 Mbit/s) or a Long Term Evolution (LTE) (4G) system (which offers a data rate of up to about 1 Gbit/s) may be used. These systems permit the transmission of both voice and data simultaneously. Generally, dual mode antenna 50 services the location detection chipset/component 44 and the cellular chipset/component 40.

The microphone 28 provides the user with a means for inputting verbal or other auditory commands, and can be equipped with an embedded voice processing unit utilizing human/machine interface (HMI) technology known in the art. Conversely, speaker(s) 30, 30′ provide verbal output to the vehicle occupants and can be either a stand-alone speaker 30 specifically dedicated for use with the telematics unit 14 or can be part of a vehicle audio component 60, such as speaker 30′. In either event and as previously mentioned, microphone 28 and speaker(s) 30, 30′ enable vehicle hardware 26 and telematics service call center 24 to communicate with the occupants through audible speech. The vehicle hardware 26 also includes one or more buttons, knobs, switches, keyboards, and/or controls 32 for enabling a vehicle occupant to activate or engage one or more of the vehicle hardware components. In one example, one of the buttons 32 may be an electronic pushbutton used to initiate voice communication with the telematics service provider call center 24 (whether it be a live advisor 62 or an automated call response system 62′) to request services, to initiate a voice call to another mobile communications device, etc.

The audio component 60 is operatively connected to the vehicle bus 34 and the audio bus 58. The audio component 60 receives analog information, rendering it as sound, via the audio bus 58. Digital information is received via the vehicle bus 34. The audio component 60 provides AM and FM radio, satellite radio, CD, DVD, multimedia and other like functionality independent of the infotainment center 56. Audio component 60 may contain a speaker system (e.g., speaker 30′), or may utilize speaker 30 via arbitration on vehicle bus 34 and/or audio bus 58. In an example, upon i) determining that the vehicle driver's eyes are or face is focused on a particular in-vehicle object and ii) altering the functionality of the object in response to the determination, one or more in-vehicle systems command the audio component 60 to play an audible message (e.g., through one or more of the speakers 30, 30′) to the vehicle driver, where the message is related to the task of driving. In one example, the telematics unit 14 is programmed to send the command signal to the audio component 60. In another example, the command signal may be sent to the audio component 60 directly from a sensor module 66.

Still referring to FIG. 1, the vehicle crash and/or collision detection sensor interface 52 is/are operatively connected to the vehicle bus 34. The crash sensors 54 provide information to the telematics unit 14 via the crash and/or collision detection sensor interface 52 regarding the severity of a vehicle collision, such as the angle of impact and the amount of force sustained.

Other vehicle sensors 64, connected to various sensor interface modules 66 are operatively connected to the vehicle bus 34. Example vehicle sensors 64 include, but are not limited to, gyroscopes, accelerometers, speed sensors, magnetometers, emission detection and/or control sensors, environmental detection sensors, and/or the like. One or more of the sensors 64 enumerated above may be used to obtain vehicle data for use by the telematics unit 14 or the call center 24 (when transmitted thereto from the telematics unit 14) to determine the operation of the vehicle 12. For instance, data from the speed sensors may be used to determine a then-current vehicle speed, which may be used, in part, to determine when to initiate the altering of the functionality of the display 80 (or other object). Additionally, examples of sensor interface modules 66 include powertrain control, climate control, body control, and/or the like. In one example, the sensor module 66 may be configured to send signals including data obtained from one or more of the sensors 64 to the telematics unit 14. In another example, the sensor module 66 sends signals directly to another in-vehicle system or component such as, e.g., the audio component 60, as briefly mentioned above.

The vehicle hardware 26 includes the display 80, as mentioned above. In one example, a single module contains both the telematics unit 14 and the display 80. The single module can include two processors (e.g., a communications processor 36 and an entertainment processor 92), one of which controls the communications and the other of which controls the infotainment (e.g., audio, visual, etc.). Two separate processors ensure that neither of the components 14 or 80 is compromised when the processor 92, 36 of the other component 80, 14 is tied up. For example, the functions of the telematics unit 14, which are controlled by the processor 36, are not compromised by entertainment applications run by the processor 92. When the telematics unit 14 and display 80 (and/or the audio component 60) are part of the same module, a vehicle bus 34 is not required for the transmission of signals between the components 14, 80 (and/or 60). In another example, the telematics unit 14 and the display 80 are part of a single module, but a single processor (e.g., processor 36) runs the applications of the telematics unit 14 and the display 80 (and/or audio component). In still another example, separate modules respectively contain the telematics unit 14 and the display 80. In this example, each module has a separate processor 36, 92 that separately control the functions of the telematics unit 14 and the display 80.

The display 80 may be any human-machine interface (HMI) disposed within the vehicle 12 that includes audio, visual, haptic, etc. The display 80 may, in some instances, be controlled by or in network communication with the audio component 60, or may be independent of the audio component 60. Examples of the display 80 include a VFD (Vacuum Fluorescent Display), an LED (Light Emitting Diode) display, a driver information center display, a radio display, an arbitrary text device, a heads-up display (HUD), an LCD (Liquid Crystal Diode) display, and/or the like.

As mentioned above, the display 80 includes or is in communication with an internal processor 92 (such as, e.g., a micro controller, a controller, a microprocessor, or the like) that is operatively associated with a display screen 94 (shown in FIGS. 2A and 2B). The processor 92 (which may also be referred to herein as the object processor 92) includes an application (e.g., computer program code encoded on a computer readable medium) for automatically altering a functionality of the display 80 in response to receiving the indication from, for example, the telematics unit 14 or a tracking device 96 that the vehicle driver's focus is directed toward the display 80. In an example, the processor 92 immediately initiates the automatic altering of the functionality of the display 80 as soon as a signal to do so is received from the telematics unit 14 or the tracking device 96.

In instances where the display 80 is part of a separate module from the telematics unit 14 (as shown in FIG. 1), the signal including the indication to alter the functionality of the display 80 may be sent from the telematics unit 14 to the display 80 via the bus 34. However, as previously mentioned, the display 80 may be part of the same module as the telematics unit 14. In this case, the signal may be sent from the telematics unit 14 directly to the display 80 without having to use the vehicle bus 34.

It is further contemplated that the display 80 may be driven by an off-board server, which may be associated with the telematics service provider. The off-board server may be part of the call center 24 or part of a data center if the system 10 includes a data center and a plurality of individual call centers, as briefly described below. A data message may be sent to the server to alter the functionality of the display 80. In this example, the vehicle sensor 64 transmits a signal to the telematics unit 14, where this signal indicates, e.g., that the vehicle 12 has exceeded a threshold speed to activate the altering of the functionality of, e.g., the display 80. In response to the signal, the telematics unit 14 sends a message to the server, which sends another message back to the telematics unit 14 including the revised image to be shown on the display 80 (e.g., a phrase such as “Eyes on the road, please”). In another example, the server sends the other message back to the telematics unit 14, where this message includes an instruction for the display 80 to show a default image that has been previously stored in the processor 36 associated with the telematics unit 14 or a processor 92 associated with the display 80. This default image may include any graphics and/or text previously designed, e.g., by the manufacturer of the vehicle 12.

In still other instances, the tracking device 96 may be configured to transmit the signal directly to the display 80, and thus the telematics unit 14 is not involved.

As such, the functionality of the display 80 may be altered via three different mechanisms: i) on command from a message generated by the telematics unit 14, ii) on command from a message generated by the server and transmitted through the telematics unit 14, or iii) on command directly from the tracking device 96. The first mechanism involves sending a signal from the tracking device 96 to the telematics unit 14, and then sending a signal from the telematics unit 14 to the display 80 to alter the functionality of the display 80. The second mechanism is similar to the first mechanism, except that upon receiving the signal from the tracking device 96, the telematics unit 14 sends a signal to the server and then server sends a return signal back to the telematics unit 14 (which may include a message to be displayed on the display 80 when the functionality is altered). In this example, the telematics unit 14 then sends another signal to the display 80 to have its altered functionality. The message sent from the telematics unit 14 may include the message (received from the server) to be displayed on the display 80 while its functionality is altered. The third mechanism does not involve the telematics unit 14, but rather a signal is sent directly from the tracking device 96 to the display 80, where this signal initiates the altering of the functionality of the display 80.

The functionality of the display 80 that may be altered includes the function that displays content on the display screen 94. For instance, how the content is displayed on the display screen 94 may be altered. In one example, if a navigation route is displayed on the display screen 94 when it is determined that the driver's eyes are or face is focused on the display 80, the processor 92 may execute a program/application that blacks out the screen 94 (so that the navigation route is not viewable at all) or simplifies the navigation route content (such as the navigational map) so that only pertinent information that is immediately required (such as, e.g., the next turn instruction) is illustrated at the time of altering. Other functions of the display 80 that may be altered include the number of command button choices available to the vehicle driver (e.g., limit the command options to those pertaining to the application then-currently being run on the display 80), the amount of text shown on the display 80 per item displayed (e.g., the navigational map may be displayed in a simplified form such that only an impending maneuver is shown), the amount of pictures and/or graphics shown on the display 80 (e.g., all pictures and/or graphics may be removed), the font size of the displayed text (e.g., all of the content would still be shown on the display 80, but pertinent and/or urgent information may be illustrated with an increased font size), and/or the contrast ratio between pertinent/urgent text and the background palette of the display 80 (e.g., the background palette may be faded slightly so that the text stands out).

The processor 92 associated with the display 80 may also include computer program code for changing the altered functionality of the display 80 back to its original functionality. This may be accomplished in response to another signal received from the telematics unit 14 or the tracking device 96. This other signal is sent after the system determines (e.g., via the tracking device 96) that the driver's focus has been turned away from the display 80 and is back on the road.

As previously mentioned, the vehicle 12 further includes the tracking device 96 that is operatively disposed inside the vehicle interior 102. In an example, the tracking device 96 is an eye-tracking device that is configured to monitor an eye position of the vehicle driver while the vehicle 12 is in operation. For instance, the eye-tracking device 96 may be used to measure the driver's eye position (e.g., the point of gaze) and the movement of the driver's eyes (e.g., the motion of the eyes relative to the driver's head). This may be accomplished by utilizing a facial imaging camera 98, which may be placed inside the vehicle interior 102 in any position that is in front of (either directly or peripherally) the vehicle driver. Examples positions for the facial imaging camera 98 include on the rearview mirror (as shown in FIGS. 2A and 2B), on the dashboard, on the mounting stem of the steering wheel, or the like. This camera 98 is configured to take images or video of the vehicle driver's face while driving, and the tracking device 96 is further configured to extract the driver's eye position from the images/video. In another example, the movement of the driver's eyes is determined by light (such as infrared light) reflected from the cornea of the eye, which is sensed by a suitable electronic device (which can be part of the tracking device 96) or an optical sensor (not shown in FIG. 1). The information pertaining to the eye motion may then be utilized (e.g., by a processor 100, shown in FIGS. 2A and 2B, associated with the eye tracking device 96) to determine the rotation of the driver's eyes based on changes in the reflected light.

The processor 100 associated with the eye-tracking device 96 executes computer program code encoded on a computer readable medium which directs the eye-tracking device 96 to monitor the eye position of the vehicle driver while he/she is driving. Upon determining that the driver's eye position has changed, the eye-tracking device 96, via the processor 100, is configured to determine the direction at which the driver's eyes are now focused. If, for example, the vehicle driver's eye position is such that his/her eyes are focused on the display 80, the eye-tracking device 96 is configured to send a signal to the telematics unit 14, via the bus 34, indicating that the driver's eyes are focused on or in the direction of the display 80.

It is to be understood that the eye-tracking device 96 continues to monitor the eye position of the driver's eyes so that the eye-tracking device 96 can later determine when the driver's eyes are positioned away from the display 80 (for example, back on the road). When this occurs, the eye-tracking device 96 is further configured to send another signal to, for example, the telematics unit 14 or the display 80 indicating that the driver's eyes are no longer focused on the display 80 but rather are focused in a forward direction. In response to receiving this signal, the telematics unit 14 can initiate another signal (alone or in combination with the server) for the display 80 to resume its original functionality or the display 80 can simply resume its original functionality.

In another example, the tracking device 96 may be a facial imaging device. This device also uses an imaging or video camera (such as the camera 98 shown in FIGS. 2A and 2B) to take images/video of the driver's face while he/she is operating the vehicle 12. The processor 100 associated with the facial imaging device 96 uses the images/video to determine that the driver's then-current line-of-sight based, at least in part, on the facial position of the driver. The facial position may be determined, for example, by detecting the angle at which the driver's head is positioned in vertical and horizontal directions.

Similar to the eye-tracking device described above, the facial imaging device also has a processor associated therewith that executes an application/computer readable code. The application commands the device to monitor the facial position of the vehicle driver while the vehicle is in operation. This information is ultimately used to trigger the altering of the functionality of the display 80, in a manner similar to that previously described when the tracking device 96 used is an eye-tracking device.

As mentioned above, the system 10 include the carrier/communication system 16. A portion of the carrier/communication system 16 may be a cellular telephone system or any other suitable wireless system that transmits signals between the vehicle hardware 26 and land network 22. According to an example, the wireless portion of the carrier/communication system 16 includes one or more cell towers 18, base stations 19 and/or mobile switching centers (MSCs) 20, as well as any other networking components required to connect the wireless portion of the system 16 with land network 22. It is to be understood that various cell tower/base station/MSC arrangements are possible and could be used with the wireless portion of the system 16. For example, a base station 19 and a cell tower 18 may be co-located at the same site or they could be remotely located, or a single base station 19 may be coupled to various cell towers 18, or various base stations 19 could be coupled with a single MSC 20. A speech codec or vocoder may also be incorporated in one or more of the base stations 19, but depending on the particular architecture of the wireless network 16, it could be incorporated within an MSC 20 or some other network components as well.

Land network 22 may be a conventional land-based telecommunications network that is connected to one or more landline telephones and connects the wireless portion of the carrier/communication network 16 to the call/data center 24. For example, land network 22 may include a public switched telephone network (PSTN) and/or an Internet protocol (IP) network. It is to be understood that one or more segments of the land network 22 may be implemented in the form of a standard wired network, a fiber or other optical network, a cable network, other wireless networks, such as wireless local networks (WLANs) or networks providing broadband wireless access (BWA), or any combination thereof.

The call centers 24 of the telematics service provider (also referred to herein as a service center) are designed to provide the vehicle hardware 26 with a number of different system back-end functions. According to the example shown in FIG. 1, one service center 24 generally includes one or more switches 68, servers 70, databases 72, live and/or automated advisors 62, 62′, processing equipment (or processor) 84, as well as a variety of other telecommunication and computer equipment 74 that is known to those skilled in the art. These various telematics service provider components are coupled to one another via a network connection or bus 76, such as one similar to the vehicle bus 34 previously described in connection with the vehicle hardware 26.

The processor 84, which is often used in conjunction with the computer equipment 74, is generally equipped with suitable software and/or programs enabling the processor 84 to accomplish a variety of service center 24 functions. Further, the various operations of the service center 24 are carried out by one or more computers (e.g., computer equipment 74) programmed to carry out some of the tasks of the service center 24. The computer equipment 74 (including computers) may include a network of servers (including server 70) coupled to both locally stored and remote databases (e.g., database 72) of any information processed.

Switch 68, which may be a private branch exchange (PBX) switch, routes incoming signals so that voice transmissions are usually sent to either the live advisor 62 or the automated response system 62′, and data transmissions are passed on to a modem or other piece of equipment (not shown) for demodulation and further signal processing. The modem preferably includes an encoder, as previously explained, and can be connected to various devices such as the server 70 and database 72.

It is to be appreciated that the service center 24 may be any central or remote facility, manned or unmanned, mobile or fixed, to or from which it is desirable to exchange voice and data communications. As such, the live advisor 62 may be physically present at the service center 24 or may be located remote from the service center 24 while communicating therethrough.

The communications network provider 90 generally owns and/or operates the carrier/communication system 16. The communications network provider 90 includes a mobile network operator that monitors and maintains the operation of the communications network 90. The network operator directs and routes calls, and troubleshoots hardware (cables, routers, network switches, hubs, network adaptors), software, and transmission problems. It is to be understood that, although the communications network provider 90 may have back-end equipment, employees, etc. located at the telematics service provider service center 24, the telematics service provider is a separate and distinct entity from the network provider 90. In an example, the equipment, employees, etc. of the communications network provider 90 are located remote from the service center 24. The communications network provider 90 provides the user with telephone and/or Internet services, while the telematics service provider provides a variety of telematics-related services (such as, for example, those discussed hereinabove). The communications network provider 90 may interact with the service center 24 to provide services (such as emergency services) to the user.

While not shown in FIG. 1, it is to be understood that in some instances, the telematics service provider operates a data center, which receives voice or data calls, analyzes the request associated with the voice or data call, and transfers the call to an application specific call center associated with the telematics service provider. It is further to be understood that the application specific call center may include all of the components of the data center, but is a dedicated facility for addressing specific requests, needs, etc. Examples of application specific call centers include, but are not limited to, emergency services call centers, navigation route call centers, in-vehicle function call centers, or the like.

The call center 24 components shown in FIG. 1 may also be virtualized and configured in a Cloud Computer, that is, Internet-based computing environment. For example, the computer equipment 74 may be accessed as a Cloud platform service, or PaaS (Platform as a Service), utilizing Cloud infrastructure rather than hosting computer equipment 74 at the call center 24. The database 72 and server 70 may also be virtualized as a Cloud resource. The Cloud infrastructure, known as IaaS (Infrastructure as a Service) typically utilizes a platform virtualization environment as a service, which may include components such as the processor 84, database 72, server 70, and computer equipment 74. In an example, application software and services (such as, e.g., navigation route generation and subsequent delivery to the vehicle 12) may be performed in the Cloud via the SaaS (Software as a Service). Subscribers, in this fashion, may access software applications remotely via the Cloud. Further, subscriber service requests may be acted upon by the automated advisor 62′, which may be configured as a service present in the Cloud.

Examples of the method of monitoring a vehicle driver will now be described in conjunction with FIGS. 1, 2A, 2B, and 3. These examples of the method are accomplished, and are described hereinbelow, when the vehicle 12 is in operation. It is to be understood that the method may be applied when the vehicle 12 is in operation, or in other situations, for example, when the vehicle 12 is not being operated by the vehicle driver (such as when the vehicle 12 is parked or stopped) or when monitoring a person in the vehicle that is not the vehicle driver (such as when the person being monitored is a vehicle passenger). Following the method(s) disclosed herein, one skilled in the art could modify the instant disclosure to accommodate these other variations. For example, when monitoring a passenger, the method may be accomplished as described herein except that the tracking device 96 may be operated to monitor a passenger rather than the driver.

Additionally, the examples of the method will be described below utilizing i) the display 80 as the object disposed inside the vehicle interior 102 whose functionality may be altered, and ii) an eye-tracking device as the tracking device 96 also disposed inside the vehicle interior 102. In these examples, the eye-tracking device 96 is connected to the rearview mirror, as shown in FIGS. 2A and 2B.

The vehicle 12 may be considered to be in operation after the driver physically enters the interior 102 of the vehicle 12 (such as through the driver-side door), and physically activates the vehicle ignition system. Activating the vehicle ignition system may be accomplished by placing a vehicle ignition key into a key slot inside the vehicle 12, and turning the key to power on the vehicle 12. The vehicle ignition may otherwise be activated via other known means, such as by pressing an ignition button disposed on the dashboard, steering consol, or other suitable spot inside the vehicle interior 102, or by using a remote starter.

Once the vehicle driver has powered on the vehicle 12, the driver may control the operation of the vehicle 12 by placing the transmission system into a mode other than park. The vehicle 12 is set into motion, for example, at least when the vehicle driver has released the brake pedal. The driver may control the speed of the vehicle 12 by applying pressure to the gas pedal (to increase speed), by releasing at least some pressure from the gas pedal (to decrease speed), or by completely releasing the gas pedal and applying the brake pedal (to slow down and/or to stop the vehicle).

As soon as the vehicle 12 is in operation and the vehicle 12 has reached a predefined speed, the eye-tracking device 96 is activated so that the device 96 can monitor the vehicle driver. Since an eye-tracking device is used in this example, the eye position of the driver is monitored. It is to be understood that if the tracking device 96 is a facial imaging camera, the facial position of the vehicle driver would be monitored instead. Activation of the eye-tracking device 96 may occur, for example, when the vehicle 12 exceeds any predefined, calibratable speed, such as 3 mph, 5 mph, or the like. It is to be understood that any vehicle speed may be set as the minimal threshold speed (i.e., the predefined speed) for activating the eye-tracking device 96.

In an example, the telematics unit 14 receives data from various vehicle systems indicating that the vehicle 12 is in fact in operation, and that the vehicle 12 is traveling above the predefined speed. For instance, the telematics unit 14 receives vehicle data from the transmission system that the vehicle 12 is then-currently in a drive mode, and also receives periodic updates of the vehicle speed (e.g., every second) from one or more speed sensors of the vehicle 12. The processor 36 associated with the telematics unit 14 compares the vehicle speed data to the previously set threshold value. When the telematics unit 14 determines, via the processor 36, that the vehicle 12 has exceeded the predefined speed, the telematics unit 14 generates a signal that is received and processed by the processor 100 associated with the eye-tracking device 96 to activate the device 96.

It is to be understood that the eye-tracking device 96 remains activated so long as the vehicle 12 is in operation and, in some instances, as long as the vehicle speed exceeds the predefined value. In instances where the vehicle is actually turned off (e.g., the ignition key is actually removed from the ignition slot), the eye-tracking device 96 will turn off as well. However, in instances where the vehicle 12 is stopped (e.g., at a traffic light), or is travelling at a speed below a predefined vehicle speed (i.e., the threshold value mentioned above), or the transmission system is changed into a park mode, but the vehicle 12 has not been turned off, the eye-tracking device 96 may remain in the monitoring mode or may go into a sleep mode. The device 96 may remain in the sleep mode until i) the vehicle 12 starts moving and exceeds the predefined speed, or ii) the vehicle 12 is turned off. In some cases, if the vehicle 12 speed remains below the threshold value for a predefined amount of time (e.g., 30 seconds, 1 minute, etc.), the device 96 may automatically shut off. In other instances, once the tracking device 96 is activated, it may remain in an on state until the vehicle 12 is powered off.

Once the eye-tracking device 96 has been activated and as long as it remains activated (e.g., not in sleep mode), an eye position of the vehicle driver is continuously monitored, via the eye-tracking device 96. The monitoring of the eye position of the vehicle driver includes determining the direction that the vehicle driver's eyes are pointed while he/she is operating the vehicle 12. In one example, the monitoring is accomplished by taking a plurality of still images or a video of the vehicle driver's face using the imaging device (such as, e.g., the camera 98) associated with the eye-tracking device 96. It is noted that the camera 98 may be directly attached to the eye-tracking device 96, as shown in FIGS. 2A and 2B, or the camera 98 may be remotely located from the eye-tracking device 96. In this latter instance, the camera 98 may be placed in a position inside the vehicle interior 102 that is in front of the vehicle driver (e.g., in order to take images/video of the driver's face), and the eye-tracking device 96 may be located elsewhere, such next to or part of the module containing the telematics unit 14. The camera 98 may therefore be in operative communication with the eye-tracking device 96 via the vehicle bus 34.

The processor 100 associated with the eye-tracking device 96 extracts the position of the driver's eyes from the images/video taken by the camera 98, and compares the extracted eye position with a previously determined eye position. The eye position may be extracted, for instance, by using contrast to locate the center of the pupil and then using infrared (IR) non-collimated light to create a corneal reflection. The vector between these two features may be used to compute a gaze intersection point with a surface after calibration for a particular person. This previously determined eye position is the direction that the vehicle driver's eyes would have to be pointed towards for the processor 100 to conclude that the vehicle driver's eyes are focused on the object (in this case, the display 80) disposed inside the vehicle interior 102. An example of an instance where the vehicle driver's eyes are directed toward the display 80 is shown in FIG. 2A. The dotted line arrow pointed from the driver's eyes to the display 80 indicates the direction in which the driver's eyes are pointing. The portion of the dotted line arrow from the tracking device 96 to the driver's eyes illustrates part of the line of sight of the tracking device 96 when in the monitoring mode.

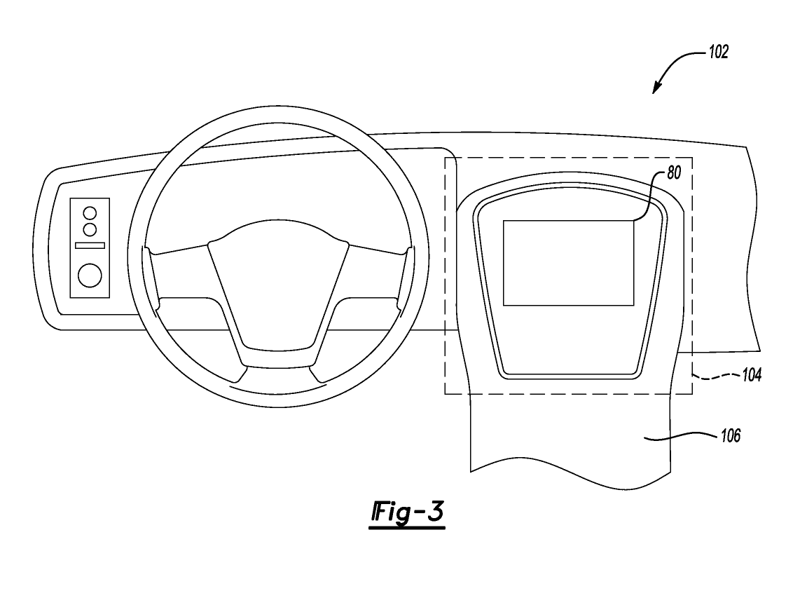

The processor 100 associated with the eye-tracking device 96 may determine that the driver's eyes are pointing toward the object, based on a direct line-of-sight measurement from the driver's eyes to the object. The processor 100 may otherwise determine that the driver's eyes are pointing toward the object upon detecting that the driver's eyes are pointing within the general proximity of the object. The general proximity measurement may be accomplished, via a software program executed by the processor 100, by constructing a fence 104 around the object (e.g., the display 80), where the fence 104 defines the boundaries of the glance direction of the vehicle driver that are directed toward the object. This is semi-schematically shown in FIG. 3. For example, in instances where the display 80 is located in a center console 106 of the vehicle interior 102 (as shown in FIG. 3), the fence 104 may be constructed around all or a portion of the center console 106 so that the fence 104 captures any potential eye positions of the driver that are within the general proximity of the display 80. In other words, the fence 104 may cover enough area surrounding the display 80 so that the eye-tracking device 96 picks up any driver glances directed toward the display 80, or even glances directed toward the center console 106 within which the display 80 is mounted.

It is to be understood that the fence 104 may be constructed to be as large as or as small as desired. For instance, if the center console 106 containing the display 80 also contains one or more other objects that the driver may look at while driving, such as, e.g., the dial for the in-vehicle audio component 60, the fence 104 may be constructed so that it covers only the area of the center consol 106 including the display 80. If, however, it is desired to monitor the vehicle driver's glances toward both the display 80 and the audio component 60 dial, then the fence 104 may be constructed around both of these objects.

In an example, the processor 100 of the eye-tracking device 96 determines that the eye position of the driver is directed toward the display 80 by comparing the driver's then-current eye position (which was extracted from the images/video taken by the camera 98) to the boundary identified by the fence 104 constructed around the display 80. If the eye position falls within the boundary, and thus within the fence 104, the processor 100 concludes that the driver is in fact looking at the display 80. Upon making this conclusion, the eye-tracking device 96 monitors the amount of time that the driver's eye position is focused on the display 80. In instances where the amount of time exceeds a predefined threshold (e.g., 1.5 seconds, 2 seconds, etc.), in one example, the eye-tracking device 96 automatically sends a signal, via the bus 34, to the telematics unit 14 indicating that the vehicle driver's eyes are focused on the display 80. In response to this signal, the telematics unit 14 retrieves or requests the then-current vehicle speed of the vehicle 12 from the onboard speed sensor(s), and determines whether or not the vehicle 12 is traveling at a speed exceeding the predefined threshold described above. If the speed threshold is exceeded, then the telematics unit 14 sends a signal to the display 80 to automatically alter its functionality.

In another example, the eye-tracking device 96 automatically sends a signal to the telematics unit 14, which in turn sends a signal to an off-board server. In this example, the signal is sent to the telematics unit 14 after the vehicle 12 has exceeded the threshold speed. Prior to the tracking device 96 sending any signals indicative of the eye position, the speed signal may be sent from the telematics unit 14 to the tracking device 96. In response to the signal sent from the telematics unit 14, the server generates another signal which is sent back to the telematics unit 14, where this other signal includes instructions for altering the functionality of the display 80. The telematics unit 14 then sends a signal to the display 80 to initiate the alteration.

In yet another example, the speed sensors on-board the vehicle 12 may send a speed signal directly to the eye-tracking device 96, and the eye-tracking device 96 in turn sends a signal directly to the display 80 to initiate alteration as soon as the device 96 detects that the driver's eyes are focused towards the display 80. In one example, the then-current speed is not reevaluated. Since the eye-tracking device 96 has been activated and speed signals are sent directly thereto, the eye-tracking device 96 is programmed to recognize that the threshold speed has been or is being exceeded.

It is to be understood that the predefined amount of time that the driver's eye position is directed toward the display 80 (also referred to herein as the glance time) may be established as a preset value based, at least in part, on standard driving conditions and/or environmental conditions. For instance, the predefined amount of time may be a default setting, which may be applied for any conditions that appear to be standard driving conditions (e.g., a single passenger is present in the vehicle 12) and/or environmental conditions (e.g., city travel with a nominal amount of traffic). This default setting may be adjusted, however, based, at least in part, on a driver workload surrounding the exterior of the vehicle 12 (i.e., the environment within which the vehicle 12 is being driven). In some cases, the amount of time that the driver can view the display 80 before its functionality is altered (based, at least in part, on the signal generated by the eye-tracking device 96 in response to the monitoring) may be adjusted to be less than the default value, i.e., the amount of time that would be allowed under standard driving conditions described above. For example, if the vehicle 12 is being driven in a congested environment (such as on 42nd Street in Manhattan, N.Y. at 12:00 p.m.), the telematics unit 14 may be programmed to decrease the glance time. Decreased or increased glance times may be based upon geographic areas and/or times of day. For example, when the telematics unit 14 recognizes a congested area and/or congested travel time, the amount of time that the driver can view the display 80 may be adjusted to be less than the default value. In other cases, the amount of time of that the driver can view the display 80 before its functionality is altered may be more than the default value. For example, if the vehicle 12 is being driven along a relatively straight country road (i.e., a less congested area), the glance time may be increased above the default value. Thus, when the telematics unit 14 recognizes a less congested area and/or a less congested travel time, the amount of time that the driver can view the display 80 may be adjusted to be more than the default value.

The adjustment to the amount of time that the driver may focus his/her eyes/face on the display 80 before its functionality is altered may be determined prior to driving the vehicle 12, and may be adjusted after the vehicle 12 is driven. The time may be set, for example, based on the location within which the vehicle 12 is typically driven, which may be defined by a radius constructed around the garage address of the vehicle owner (who is most likely also the vehicle driver). The garage address is the residential address of the registered vehicle owner. The time may also be preset based on the type of environment in which the vehicle owner (or driver) lives. For example, if the garage address is in a geographic region that experiences rain or snow for at least part of a calendar year (e.g., Alaska, Minnesota, Maine, etc.) or is in a geographic region that has windy roads adjacent cliffs (e.g., Maui), the default glance time may be relatively short. Off-board navigation information about geographic areas may also be used to adjust the glance time.

The glance time may also be set based on habits of the vehicle driver and/or habits of other drivers, which may be learned from data obtained by the telematics unit 14 from the respective telematics units of the other drivers (e.g., via vehicle-to-vehicle (V2V) communication). Additionally, the glance time may be based upon one or more of the above-listed factors.

The adjustment to the amount of time that the driver may focus his/her eyes/face on the display 80 may also be determined in real time, for example, upon observing the environment within which the vehicle 12 is then-currently traveling. In this example, the environment may be detected using various vehicle sensors (e.g., rain sensors, sensors associated with the traction control system, etc.) or information obtained from the navigation system, the Cloud, other vehicles (e.g., via V2V communication), and/or traffic or weather updates from the call center 24 or other facility (e.g., a weather station, traffic control station, police station, satellite radio, etc.). The data obtained may be used in an algorithm, run by the processor 36 of the telematics unit 14, which calculates the adjusted time and then outputs the adjusted time to the processor 100 of the tracking device 96. In one example, the algorithm may calculate the adjusted time (tᵢ) utilizing a maximum time (tₘₐₓ) from which various times may be subtracted based on a multiplier. For instance, tᵢ may be determined according to the following equation:

tᵢ=tₘₐₓ=wᵢt_{w}=lᵢtₗ=dᵢt_{d} Equation (1)

where wᵢ, lᵢ, and dᵢ are coefficients from 0 to 1 for weather (w), driver workload (1), and daylight (d), respectively; and t_{w}, t₁, and t_{d} are the maximum time subtractions for the worst case scenario for the weather, driver workload, and daylight, respectively. For instance, a worst case scenario for the weather may include a hurricane evacuation, while a worst case scenario for the driver workload may include a chaotic scene inside the vehicle such as, e.g., all of the vehicle seats being filled during a left turn while the driver is changing compact discs (CDs) in the presence of an extreme braking action. A worst case scenario for the daylight may include nighttime with a waning moon. As one illustrative example, t_{w} and t₁ may each be about 1 second, and t_{d} may be about 0.5 seconds. However, even in the worst case scenarios, it is believed that the reduced threshold would not be dropped below 1 second.

The predefined amount of time that the driver's eyes may be focused on the display 80 before its functionality is altered may also be adjusted based, at least in part, on a driver workload from within the vehicle interior 102. The interior driver workload includes any in-vehicle occurrence that may affect the driver (i.e., a summation of all of the circumstances that the driver must comprehend, prioritize, and/or evaluate while driving). In one example, the interior driver workload includes the driver being engaged in a complicated driving maneuver (such as extreme braking to avoid a driving accident) while other circumstances are present for the vehicle driver to comprehend (such as if the driver is also eating at the time the extreme braking occurs). In another example, the driver workload may include an ambient noise level inside the vehicle interior 102, where the noise may be picked up/sensed by the microphone 28. The ambient noise may be generated by vehicle passengers (e.g., one or more of whom are engaged in conversation while the vehicle 12 is in motion), and/or music or other audible tones being played through the audio component 60 or other audio device inside the vehicle 12 (e.g., a portable boom box). The driver workload may also be affected by the number of vehicle 12 passengers, which may be detected by sensors associated with the vehicle seat belts, pressure sensors in the vehicle 12 seats, etc.

As previously mentioned, the telematics unit 14 initiates the altering of the functionality of the display 80 by transmitting a signal to the display processor 92 with instructions to alter its functionality. In an example, the functionality of the display 80 that is altered is how the content is displayed on the display screen 94. In some instances, any content then-currently being shown on the display screen 94 (such as, e.g., a navigation route, radio station and song information, etc.) automatically fades or blacks out, leaving behind a blank or black screen. In another example, the content then-currently being shown on the display screen 94 is simplified so that the driver is presented only with pertinent and/or urgent content on the display screen 94.

Upon altering the content shown on the display 80 (e.g., via fading out or simplifying the content), a message may appear on the display screen 94, where such message is directed to the vehicle driver, and relates to the task of driving. For instance, the message may be a textual message that appears on the blank/black screen (in instances where the content was faded out) or over the simplified content (which becomes a background when the content is simplified). The textual message may relate to the task of driving. In other instances, the message may be a pictorial message that appears on the blank/black screen or over the simplified content. The pictorial message may take the form of an icon, picture, symbol, or the like that relates to the task of driving. One example of a pictorial message is shown on the display screen 94 in FIG. 2A. The message to the driver may also be a combination of a textual message and a pictorial message.

As such, in an example of the method disclosed herein, after altering the displaying of the content on the display screen 94, a textual message and/or a pictorial message is displayed on the screen 94.

In still another example, when the content shown on the display 80 is altered, an audible message may be played to the vehicle driver via the in-vehicle audio system 60. This audible message may be a previously recorded message or an automated message that includes, in some form, driving related information. The audible message alone may be played to the vehicle driver upon altering the functionality of the display 80, or the audible message may be played in addition to displaying a textual and/or pictorial message on the display screen 94.

It is to be understood that the audio component 60 must be powered on so that the audible message can be played to the vehicle driver via the speakers 30, 30′. In instances where the audio component 60 is powered on and other audible content (e.g., music, a literary work, etc.) is then-currently being played on the audio component 60, the content then-currently being played will fade out prior to playing the message to the vehicle driver. In some cases, the previously played content will fade back in as soon as the message is played, while in other cases the previously played content will not fade back in until the driver refocuses his/her eyes/face in a forward direction (e.g., back toward the road). In this example, the audible message may be repeatedly played to the driver until the driver refocuses his/her eyes/face away from the display 80.

In instances where the audio component 60 is turned off, the audible message may otherwise be played on a speaker associated with the tracking device 96 or another component operatively disposed inside the vehicle 12 (such as the rear-view mirror) and in communication with the telematics unit 14 via the bus 34. In this example, the other speaker may play the audible message on command from the telematics unit 14.

After the functionality of the display 80 has been altered (and possibly a message displayed and/or played to the driver), the eye position of the driver's eyes are further monitored by the eye-tracking device 96, at least until the processor 100 associated with the device 96 recognizes that the eye position is such that the driver's eyes are focused away from the display 80. An example of this is shown in FIG. 2B, where the portion of the dotted line arrow pointed from the driver's eyes to the windshield indicates the direction in which the driver's eyes are pointing after focusing his/her eyes/face away from the object. Upon making this recognition, the eye-tracking device 96 sends another signal to the telematics unit 14, and the telematics unit 14 in turn sends another signal to the display 80 with instruction for the display to change back to its original functionality. For instance, if the content shown on the display screen 94 was faded out, upon determining that the driver's eyes are or face is away from the object (e.g., display 80), the content previously shown on the screen 94 fades back in. Likewise, if the content was simplified, upon making the determination that the driver's focus is away from the display 80, a complete set of the content is re-displayed and/or is viewable by the vehicle driver. The content displayed on the screen 94 after functionality has been restored may or may not be the same content that was displayed when the functionality was altered.

It is to be understood that when the eye position of the vehicle driver is such that the driver's focus is away from the display 80, the driver's focus may be anywhere except for toward the display 80. The message displayed on the display screen 94 and/or played over the audio component 60 directs the driver's eyes or face to a position other than toward the display 80. In the examples provided herein, the message relates to the task of driving. Accordingly, in an example, the eye-tracking device 96 determines that the driver's eyes are away from the display 80 when the driver's eye position is directed forward.

It is to be understood that when the content is faded out or simplified upon altering the functionality of the display 80, any application running on the display 80 that is producing the content continues to run in the background. Thus, upon fading in or re-displaying a complete set of content (i.e., restoring functionality), the content now shown on the display screen 94 may be updated content. For instance, if the content that was faded out included navigation instructions, upon fading back in, the navigation instructions would be updated to reflect the then-current time and position of the vehicle 12. As such, the navigation instructions are not interrupted as a result of the altering of the display 80. In another instance, if the content included metadata of a musical work, upon fading back in, the metadata would be displayed for the musical work being played at the time of fading in. It is noted that this musical work may or may not be different from the one being played when the content was faded out. For example, if the same song is playing when the display 80 is altered and restored, the metadata illustrated on the screen 94 may be the same both before and after the alteration.

In some cases, the driver may elect to have the content being faded out or simplified audibly played over the audio component 60. For example, a navigation route may be audibly recited to the driver although the driver cannot view the route on the display 80. This allows the driver to benefit from the application that was running at the time the display's functionality was altered. The driver may elect to activate this feature at the time of altering of the display 80, for example, by responding to an inquiry provided to the driver by the telematics unit 14. The driver may respond verbally reciting the election through the microphone 28 associated with the telematics unit 14, via a button press, or the like. The automatic activation of the audible feature upon functionality alteration may otherwise be a default setting or set upon purchasing the vehicle 12. It is to be understood that, in this example, the message is audibly through the audio component 60 automatically, whether or not another message is be provided to the driver as a textual or pictorial message on the display 80. The audible feature may also be turned off upon purchasing the vehicle 12.

The changing of the altered functionality of the display 80 back into its original functionality may be accomplished upon detecting, via the eye-tracking device 96, that the vehicle driver's eye position is focused away from the display 80. This may be accomplished immediately upon making the detection, or after the eye-tracking device 96 has determined that the driver's eye position has been focused away from the display 80 for at least a predefined amount of time. In this latter example, the predefined amount of time that the driver's focus may be turned away from the display 80 to have its functionality changed back may be 1.5 seconds, 2 seconds, or any preset value. In one particular example, the functionality of the display 80 is restored when the tracking device 96 determines that the driver's eyes are focused back on the road. The amount of time that the driver's eye position is away from the display 80 may also be determined, at least in part, from a driver workload inside or outside of the vehicle, as previously described in conjunction with determining the amount of time for which the driver's eyes are focused on the display 80.

In another example, the telematics unit 14 may determine that the vehicle driver is engaged in a driving maneuver (e.g., making a left hand turn at an intersection, merging onto a highway from an entrance ramp, backing into a parking spot, or the like) at the time the functionality of the display 80 is altered. As previously described, the driving maneuver may be detected via the workload management application run by the processor 36 of the telematics unit 14, and this application utilizes data received from one or more vehicle systems and/or sensors internal and/or external to the vehicle 12 to determine what maneuver(s), if any, the vehicle 12 is then-currently performing Upon determining that the driver is engaged in the maneuver, even if it has been determined that the driver's eyes are focused away from the display 80, the telematics unit 14 does not send a signal to the display 80 to resume its original functionality until after the maneuver has been completed. As such, the telematics unit 14 continuously processes the data, via the processor 36, until the telematics unit 14 makes a determination that the driving maneuver is in fact complete. Upon making this determination, the telematics unit 14 then sends a signal to the processor 92 of the display 80 so that the functionality of the object may be restored.

It is to be understood that the functionality of the display 80 may be altered based on habits of the vehicle driver while operating the vehicle 12. These habits may include, for example, how often the driver tends to look away from the road and at the display 80 when the display 80 is displaying particular types of content. This habit may be learned by the processor 36 of the telematics unit 14 based on data continuously received from the eye-tracking device 96. For example, the data collected by the telematics unit 14 may show that every time a particular application is launched in the vehicle 12, the driver tends to excessively look at the display 80. The habit may also be learned from other vehicle drivers, which data may be obtained by their respective telematics units and shared between vehicles via, e.g., V2V communication. Any collected data may also be shared with the call center 24, which may utilize the information to design various alterations of the display 80 when displaying particular content. For example, the display 80 may be configured to exhibit less visual bits of information on the display screen 94 when a particular application is being run that displays the particular content that drivers tend to excessively focus on. Thus, the application for altering the functionality of the display 80 may be altered throughout the life of the vehicle 12 based on feedback from the vehicle 12 and/or other vehicles. Updates to the application may be downloaded wirelessly to the processor 92 that executes the application.

While several examples have been described in detail, it will be apparent to those skilled in the art that the disclosed examples may be modified. Therefore, the foregoing description is to be considered non-limiting.

1. A method of monitoring a vehicle driver, comprising:
monitoring any of an eye or a facial position of the vehicle driver via a tracking device operatively disposed in a vehicle that is then-currently in operation;
based on the monitoring, via a processor operatively associated with the tracking device, determining that the eye or facial position of the vehicle driver is such that the vehicle driver's eyes are or the vehicle driver's face is focused on an object disposed inside an interior of the vehicle; and
in response to the determining, automatically altering a functionality of the object.

2. The method as defined in claim 1 wherein the tracking device is chosen from an eye tracking device or a facial imaging device.

3. The method as defined in claim 1 wherein prior to the monitoring of the eye position, the method further comprises activating the tracking device i) when the vehicle exceeds a predefined vehicle speed, and ii) upon determining that the eye or facial position is such that the vehicle driver's eyes are or the vehicle driver's face is directed to the object for at least a predefined amount of time.

4. The method as defined in claim 3 wherein the predefined amount of time is based on a driver workload from within an interior of, or surrounding an exterior of, the vehicle.

5. The method as defined in claim 1 wherein the object is an in-vehicle display, and wherein automatically altering the functionality of the object includes fading out any content being shown on the display.

6. The method as defined in claim 1 wherein the object is an in-vehicle display, and wherein automatically altering the functionality of the object includes simplifying any content being shown on the display.

7. The method as defined in claim 1 wherein after automatically altering the functionality of the object, the method further includes showing any of a textual or pictorial message on the object.

8. The method as defined in claim 1 wherein after automatically altering the functionality of the object, the method further includes playing an audible message through an audio system operatively disposed in the vehicle, the audible message including an instruction for the vehicle driver.

9. The method as defined in claim 1, further comprising:
after automatically altering the functionality of the object, further monitoring, via the tracking device, the eye or facial position of the vehicle driver;
based on the further monitoring, via the processor operatively associated with the tracking device, determining that the eye or facial position of the vehicle driver is such that the vehicle driver's eyes are or the vehicle driver's face is focused away from the object; and
in response to the determining that the vehicle driver's eyes are or the vehicle driver's face is focused away from the object, changing the altered functionality of the object back into its original functionality.

10. The method as defined in claim 9 wherein the changing of the altered functionality of the object is accomplished by fading in content displayed on the object or displaying a complete set of content on the object.

11. The method as defined in claim 9, further comprising:
prior to changing the altered functionality of the object, detecting that the vehicle driver is engaged in a driving maneuver while the functionality of the object is altered; and
changing the altered functionality of the object back to its original functionality upon detecting that the driving maneuver has been completed.

12. A system for monitoring a vehicle driver, comprising:
an eye-tracking device operatively disposed in a vehicle, the eye-tracking device configured to monitor an eye position of the vehicle driver while the vehicle is in operation;
a processor operatively associated with the eye-tracking device, the eye-tracking device processor executing computer program code encoded on a computer readable medium for determining that the eye position of the vehicle driver is such that the vehicle driver's eyes are focused on an object disposed inside an interior of the vehicle while the vehicle is in operation; and
a processor operatively associated with the object, the object processor executing computer program code encoded on a computer readable medium for automatically altering a functionality of the object in response to the determining that the vehicle driver's eyes are directed toward the object.

13. The system as defined in claim 12, further comprising a vehicle ignition system for powering on the vehicle, the ignition system being associated with a vehicle bus for sending a signal to the eye-tracking device to activate the eye-tracking device when the vehicle is powered on.

14. The system as defined in claim 13, further comprising a telematics unit operatively disposed in the vehicle, the telematics unit being configured to send a signal to the object to initiate the automatic altering of the functionality of the object when the vehicle exceeds a predetermined vehicle speed.

15. The system as defined in claim 12 wherein the object is an in-vehicle display, and wherein the functionality of the display that is automatically altered includes displaying content on the display.

16. The system as defined in claim 15 wherein upon altering the functionality of the display, the display is configured to show a message that includes an instruction for the vehicle driver.

17. The system as defined in claim 12, further comprising an audio system operatively disposed in the vehicle, wherein upon altering the functionality of the display, the audio system is configured to play an audible message that includes an instruction for the vehicle driver.

18. The system as defined in claim 12 wherein the eye-tracking device is configured to further monitor the eye position of the vehicle driver after the functionality of the object has been automatically altered, and wherein the eye-tracking device processor is further configured to determine that the eye position of the vehicle driver is such that the vehicle driver's eyes are focused away from the object.

19. The system as defined in claim 18 wherein the object processor is further configured to change the altered functionality of the object back to its original functionality.

20. The system as defined in claim 18, further comprising a vehicle driver workload management application executable by a processor operatively associated with an telematics unit operatively disposed in the vehicle, the vehicle driver management application including computer program code encoded on a computer readable medium for detecting that the vehicle driver is engaged in a driving maneuver while the functionality of the object has been altered, wherein the object processor is further configured to change the altered functionality of the object back to its original functionality upon detecting that the driving maneuver has been completed.
